(19) United States
(12) Patent Application Publication
(10) Pub. No.: US 2006/0004641 A1
(43) Pub. Date: Jan. 5, 2006

(54) Telephone and toll-free initiated messaging business method, system and method of conducting business

(76) Inventors: Jeffrey Moore, Seattle, WA (US); Ian Eisenberg, Seattle, WA (US)

Correspondence Address: John P. luther, Esq.;Newman & Newman, LLP, Suite 610, 505 5th Avenue South, Seattle, WA, 98104, US

(21) Appl. No.: 11/173,346

(22) Filed: Jul. 1, 2005

Related U.S. Application Data
(63) Continuation-in-part of application No. 10/815,368, filed on Apr. 1, 2004.

(51) Int. Cl. G06Q 30/00

(52) U.S. Cl. 705/26

(57) ABSTRACT

The present invention provides a method for the purchase of goods and/or services, a system therefore and method of conducting business thereby which comprise and/or employ the steps of a caller or would-be purchaser calling a service provider/vendor from a land line or mobile phone device, optionally by way of a toll-free call; determining if the caller is calling from a land line or mobile phone device, and responding accordingly; if it is determined to be a mobile phone device a text or multimedia message being forwarded to the would-be purchaser's mobile phone device relating to the purchase of services and/or goods options and/or terms of procuring services and/or goods; and upon acceptance of the contents of the text or multimedia message, the would-be purchaser or caller is billed or charged a fee which allows the caller's access to telephonic and/or Internet vendor provided services and/or goods for a determined time period.

### RELATED APPLICATIONS

This application is a continuation-in-part application of U.S. patent application Ser. No. 10/815,368 filed Apr. 1, 2004, and is a continuation-in-part application of U.S. patent application Ser. No. ______, filed ______.

### COPYRIGHT NOTICE

Copyright 2005 Blue Frog Mobile, Inc. All rights reserved. A portion of the disclosure of this patent application/patent document contains material which is subject to copyright protection. The copyright owner has no objection to the facsimile reproduction by anyone of this document or patent which issues therefrom as it appears in the United States Patent and Trademark Office file and records.

### FIELD OF THE INVENTION

The present invention relates to telephone and optionally toll-free initiated purchases and/or access to remotely located goods, services and information in general, such as through the Internet, including dating and chat services, access to games and other executable products, ringtones, wallpaper for phone displays, news of any type, sports, betting and gaming, weather reports and any and all services and goods which may be provided by telephone and/or Internet venues; to the business of offering and selling goods, services and information in general; and further to remote transactions in which goods and/or services are ordered or purchased via phone devices in conjunction with telephone and toll-free calling initiation of SMS, EMS and MMS messaging from merchants or service providers, and of vendors or service providers determining the source of calling and responding in kind to land line and wireless callers.

### BACKGROUND OF THE INVENTION

Toll-free telephone services are commonly used methods by which a business/subscriber can receive collect or calls free to an end user. By the end user dialing, for instance, any number beginning with “800”, “886”, “887”, “700”, etc., or other varieties of a “toll-free” number, a call is typically routed to a regular phone number and the charge for the call is usually billed to the called number. In processing such calls a database or network operation is queried by a network switch to determine the actual destination number for the call, which is then employed by the switch to route the call through the network to an appropriate destination. Toll-free customer service lines have long been used, and toll-free calling is also known as a highly effective business tool. Such toll-free calling is also highly effective to develop market recognition and source identification, and in acquiring strong and valuable trade and service mark rights, for example, such as “1-800-BANKRUPT” which has been recognized as a property right to receive telephone calls dialed to the number 1-800-226-5787, and which is the subject of licenses. Personal toll-free numbers have also been used as effective alternatives to calling cards and pay phones, or as alternatives to business cards, such as “1-800-LAWYERS”, or “1-800-GET CHAT”, or “1-800-OWNTONE”, “1-800-SMSCHAT”, “1-800-SMSDATE”, “1-800-MMSMATE”, “1-800-TEXTDATE” and the like.

As some examples of toll-free services, PowerNet Global currently offers a stand-alone toll-free card and service, AccuDial offers toll-free numbers for the home, office, business or overseas location that one can forward anytime via a website and Kall8 On-The-Fly Programable toll-free service offers to route a custom 800 number to a business or residence and to change the number as desired by way of a secure website. Still other examples include Z-tel Bundled Unlimited and Cheap toll-free services, and toll-free services offered by Covista, Unitel and OPEX. In some recent developments, there have been some new techniques which provide Internet subscribers with a way to offer toll-free access to end users. See, for example, U.S. Pat. No. 6,181,690. In another example, there is provided the ability of a caller in one country to dial a toll-free number associated with a destination in another country with the international toll charges assessed to the call origin and with the destination network charges assessed to the destination. See U.S. Pat. No. 5,875,237.

While these and other interesting methods are constantly being developed, the employ of such hugely popular and effective toll-free services in conjunction with the equally effective and popular Short Message Service (“SMS”) text messaging and Multimedia Messaging Service (“MMS”) protocols in the sale and distribution of services and goods has not yet been made available or even explored.

SMS text messaging is an integrated message service that provides the ability to send and receive text messages globally to and from other SMS enabled devices, such as mobile telephones. The system is supported by Global System for Mobiles (GSM) and other mobile connection systems. Using the SMS, a message may be transmitted composed of up to 160 characters of any kind of text in length, and can comprise any combination of words, numbers, alphanumerics, punctuation symbols, or nessages may also be in non-text, such as binary.

SMS text messages are thought to be similar to paging systems, except that delivery of SMS messages does not require a mobile phone to be active or even within range. Messages are not sent directly to the recipient but instead are sent to a recipient via a network SMS center (SMSC), and are held in the SMSC or depository until the intended recipient's phone is active and within range. Thus, SMS messages can always be expected to be delivered to the intended recipient eventually. Another feature of the SMS system is that the sender of an SMS message can receive confirmation of message delivery, or notification of whether the short message has been delivered. In some instances, several short messages can be strung together (concatenated). Various service providers offer different uses for the SMS system, such as the Bulk SMS system which can be incorporated into an existing messaging system and used to automate and/or send personalized text messages to local, regional or global recipients. Some applications of this method include peer-to-peer messaging, SMS marketing, alerts, info-text, web-to-mobile content and various notifications. An SMS Gateway system is said to provide developers and integrators access to secure, reliable, international, high capacity SMS messaging platforms, with potential to design and deploy an array of mobile data applications through any of several APIs via protocols such as SMPP, HTTP/S, FTP, XML, COM Object and the like. SMS is used extensively and has been incorporated into existing CRM, e-mail and accounting systems with many expansive applications being reported. As can be seen, SMS messaging provides not only a convenient means for worldwide person-to-person private messaging, but also has provided a powerful business tool for discreetly sending and receiving certain types of information useful in business transactions, including up-to-date breaking news, sports and financial information. Merchant use of SMS messaging, however, has yet to be fully exploited, with even more convenient and effective use of this mode of information transmission yet to be provided.

MMS multimedia messaging, the progeny of SMS protocol, allows the ability to send multimedia messages comprising pictures, images, animations, graphics and audio, in addition to text messages, to MMS enabled cellular phones providing much more capability than SMS text messaging with many business opportunities comprising its use not yet explored.

The use of toll-free calling capability in conjunction with either or both of SMS and MMS messaging is seen to provide yet an even more powerful marketing and sales approach than SMS, MMS and other protocols used individually.

Additionally, the ability to receive telephone inquiries and/or sales orders from both land lines and mobile telephone devices, and to determine whether a customer or potential customer call is from a land line or wireless device and to offer and provide services and goods through each via appropriate channels and methods is further seen to provide distinct business advantages.

### SUMMARY OF THE INVENTION

In accordance with that set forth above, the present invention provides new and effective methods for telephone and toll-free calling initiating of telephone purchases or use of goods and services, and also SMS, EMS and MMS message-based business methods, systems for carrying out operations and a methods in general of conducting retail or any wholesale services and/or goods for purchase vending business via the use of phone devices and mobile phone services. More particularly, the present inventive method comprises in a preferred embodiment the steps of a caller, and would-be purchaser of goods and/or services, or other information, dialing an advertised telephone number, such as a toll-free number, and subsequently receiving an SMS, EMS and/or MMS message from a merchant or a merchant provider in which a text or a multimedia message sets forth, for example, inter alia, a menu of goods and/or services for purchase, terms of purchase of various services or goods for sale, and a fee schedule for purchases and/or a request for payment confirmation. Upon acceptance of the contents of the text or multimedia message, for example, for particular services and/or goods for a set fee, the caller/purchaser is then billed or charged a fee which then allows the caller/purchaser access to the advertised telephone services or the ability to download a product for a predetermined time period, for example, by use of a password or code. Upon expiration of the time period, the caller/purchaser's phone service is forwarded a second text or multimedia message requesting the caller's agreement to be billed or charged a further fee for a second predetermined time period for the advertised telephone services or goods, or an otherwise second time prescription period for telephone services and/or goods. This operation is repeated as desired for any number of cycles.

In an additional aspect of the invention, there is provided a method in which a potential customer or customer dials an advertised number, which may be a toll-free number, from either a land line or wireless phone device, and a service provider or vendor may then determine whether the call is from a land line phone or mobile phone device, and respond accordingly, for example, through a recorded message or call back to a land line user or with text or multimedia messages to a mobile phone user who is so-enabled, to provide goods and services.

The present invention with its wide array of practical embodiments and applications will be better understood with reference to the following Detailed Discussion of Preferred Embodiments with accompanying drawings.

### BRIEF DESCRIPTION OF THE DRAWINGS

FIG. 1 illustrates in a schematic flow diagram a preferred embodiment of the present invention in the use of advertised telephone numbers to access remote srervice and goods providers.

FIG. 2 illustrates by schematic flow diagram a mobile phone device goods and/or services for purchase method and system employing SMS text messages and/or MMS multimedia messages in accordance with the present invention.

FIG. 3 illustrates by schematic flow diagram another embodiment of a mobile phone device goods and/or services for purchase method and system employing SMS text message and/or MMS multimedia messages in accordance with the present invention.

FIG. 4 illustrates by schematic flow diagram another embodiment of a mobile phone device goods and/or services for purchase method and system in accordance with the present invention.

FIG. 5 illustrates by schematic flow diagram another embodiment of the present invention.

FIG. 6 illustrates by schematic flow diagram another embodiment of the present invention.

FIG. 7 illustrates by schematic flow diagram another embodiment of the present invention.

FIG. 8 illustrates a flow diagram of yet another preferred embodiment of the present invention.

### DETAILED DESCRIPTION OF PREFERRED EMBODIMENTS

All patent references, published patent applications and literature references referred to or cited herein are expressly incorporated by reference to the same extent as if each were specifically and individually indicated to be incorporated by reference. Any inconsistency between these publications and the present disclosure is intended to and shall be resolved in favor of the present disclosure.

In the following discussion, many specific details are provided to set forth a thorough understanding of the present invention. It will be obvious, however, to those skilled in the art that the present invention may be practiced without the explicit disclosure of specific details, and in some instances of this discussion, with reference to the drawings, known elements have not been illustrated in order not to obscure the present invention in unnecessary detail. Such details concerning computer networking, software programming, telecommunications and the like may at times not be specifically illustrated as such are not considered necessary to obtain a complete understanding of the core present invention, but are considered present nevertheless as such are considered to be within the skills of persons of ordinary skill in the art.

It is also noted that, unless indicated otherwise, all functions described herein maybe performed in either hardware or software, or some combination thereof. In some preferred embodiments the functions may be performed by a processor, such as a computer or an electronic data processor in accordance with code, such as computer program code, software, and/or integrated circuits that are coded to perform such functions.

Having thus prefaced this discussion, in one preferred aspect the present invention provides a novel, convenient and efficient method for conducting a services and/or goods-vending business operation by exploiting the advantages of offering and selling goods and services by way of advertised telephone numbers, and optionally the tremendous advantages and opportunities afforded by toll-free calling, as used in conjunction with the SMS text and MMS multimedia messaging systems.

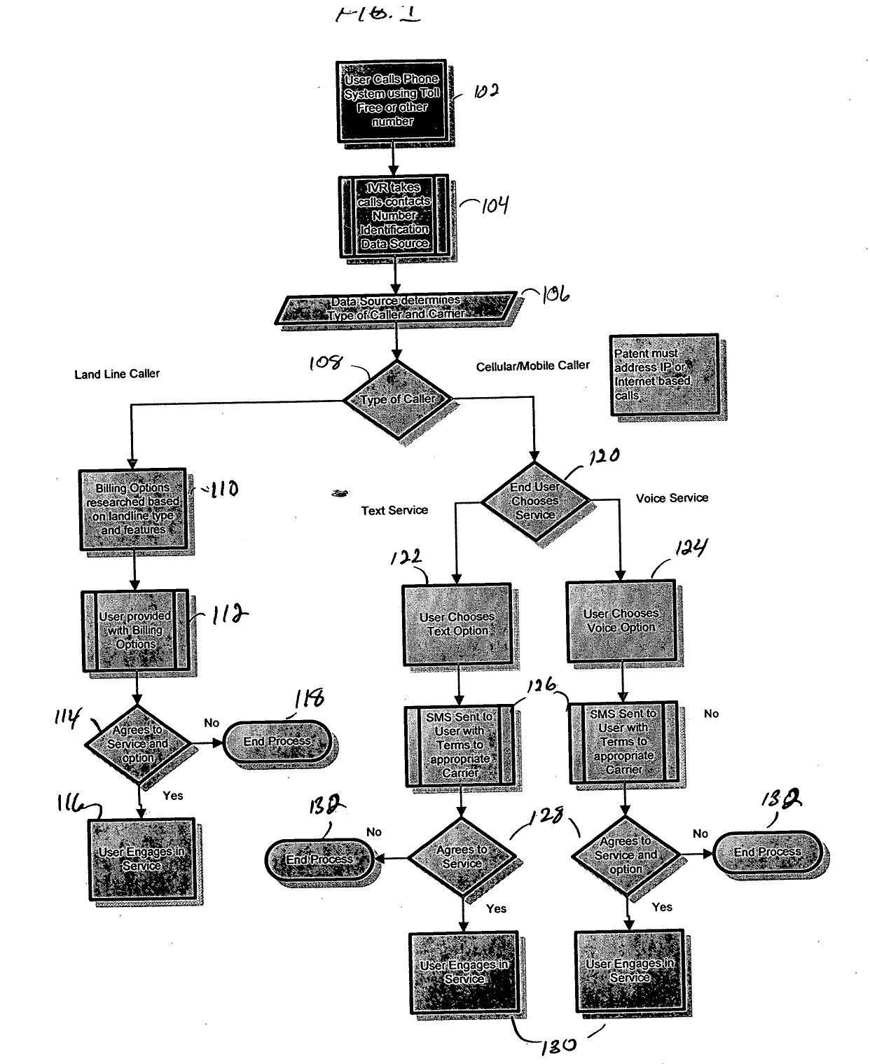

Referring now to the preferred embodiment of FIG. 1, in its broadest sense the inventive method comprises the operations of a caller, or potential purchaser of goods or services (i.e. a “would-be purchaser”), dialing an advertised or provided telephone number, which in some instances may be a toll-free number, for example, 1-800-GET CHAT, or otherwise text or multimedia messaging an advertised number, from any sort of conventional fixed or land line or mobile phone device (102) with the intent of exploring the possibility of purchasing goods and/or services through the telephone number connection. As shown, preferably an IVR (104) received calls and processes the identification of the number called from by way of an Identification Data Source (106), which determines the type of caller device (108), be it a land line or some type of mobile phone device, and the caller's carrier. Upon a determination that the caller is using a conventional land line, billing options are researched and considered based upon the land line type and available features (110). The caller-user is then provided with billing options (112) through the telephone call, such as by a prerecorded menu, or by way of a call back from the vendor or service provider, or representative thereof, or by some other type of contact. The user then agrees to the terms and/or billing options (114), and engages, for instance, in the use of offered services (116), such as a chat line, etc., or does not agree and the process ends (118).

Upon a determination that the caller is using a mobile phone device, the caller is preferably provided the choice (120) of proceeding through a text message option (122) or voice option (124). The user is then forwarded a SMS text or MMS multimedia message (126) which can set forth, for instance, inter alia, available goods and/or services for purchase, terms or purchase, a fee schedule for goods and/or services for purchase, and a request for payment confirmation, or payment terms and the like. Upon acceptance of the contents of the text or multimedia message (128), for example, for certain services and/or goods for a set fee, the caller may be billed or charged a fee which then allows the caller access, for example, to the advertised telephone services and/or goods (130) for, say, a predetermined time period, and perhaps by way of a password or code, or PIN. If the caller does not agree to the terms, the process ends (132).

In some preferred embodiments, upon completion of the time period, the caller's mobile phone device is forwarded a second text or multimedia message requesting the caller's agreement or approval to be billed or charged a further fee for a second predetermined time period for the advertised telephone services and/or goods, or otherwise for a second time prescription period, which operation, of course, can be repeated for any number cycles.

In another preferred embodiment, the present invention provides a novel, convenient and efficient method for conducting a services and/or goods-vending business operation by exploiting the advantages of offering and selling goods and services through advertised telephone numbers, including toll-free calling, and the therewith of SMS text and MMS multimedia messaging systems. This embodiment comprises the operations of a caller, or potential purchaser of goods or services (i.e. a “would-be purchaser”), dialing an advertised telephone number, such as a toll-free number, for example, “1-800-GET CHAT”, or otherwise text or multimedia messaging an advertised number, from any sort of a land line or mobile phone device with the intent of exploring the possibility of purchasing goods and/or services through the telephone number connection. Upon a determination that the caller is using a mobile phone device, the caller is then forwarded an SMS text or MMS multimedia message which can set forth, inter alia, instructions for keying in entries on the phone to access chat lines, or information as to available goods and/or services for purchase, terms of purchase, a fee schedule for goods and/or services for purchase, and a request for payment confirmation, or payment terms. Upon acceptance of the contents of the text or multimedia message, for example, for certain services and/or goods for a set fee, the caller is billed or charged a fee which then allows the caller access to the advertised telephone services and/or goods for a predetermined time period, for example, by way of a password or code, or PIN. Upon completion of the time period, the caller's mobile phone device is forwarded a second text or multimedia message requesting the caller's agreement or approval to be billed or charged a further fee for a second predetermined time period for the advertised telephone services and/or goods, or otherwise for a second time prescription period, which operation, of course, can be repeated for any number cycles.

Alternatively, upon determination that the user is calling from a land line, or a mobile phone device which is not capable of receiving text or multimedia messages, a message may be played to the user, for example, with information as to telephone numbers useful to access services, such as chat lines, for example, “413-GET-CHAT”. When the user then calls the advised number, the user's telephone number that s/he is calling from is recognized, and it is determined that the caller is a billable caller. The user may then be prompted to enter into an agreement for access to telephone services, such as payment of a set fee per month. As used herein, the terms “user” and “caller” are meant to include both users of traditional telephone land lines and users of cellular or mobile phone devices which may be capable of sending and receiving text or multimedia messages.

The Short Message Service, or SMS, protocol is well known and widely used for data transfer, or text transfer, through Short Message Service Centers (SMSC) between mobile devices and is a service provided by current GSM networks and other networks for sending short messages over a signaling channel. Using this system (and similar systems like it) an originating caller, or return caller, can dial a phone number to leave a short message, such as an alphanumeric message, on the display of a recipient mobile phone. A specific short message type handled by digital wireless networks enables receiving mobile devices to be remotely managed by a remote device management system supporting an array of different applications. Specific SMS messages and applications necessitate or require parameter change commands or specific software and applications to be applied to a digital wireless network and/or receiving mobile phone device, which are sometimes referred to as a “Configuration SMS”.

Such configuration systems may be used, for example, in methods to remotely manage GSM or GPRS-connected mobile devices from a device management application by using the SMS as a content vehicle to carry configuration parameters to be applied as contemplated to a device. SMS may also be used as a form of trigger to which a device responds by launching a connection to a management server to perform management orientated synchronization activities, such as inventory, configuration and software download. As an example of such usage, see United States published patent application No.: 2003/0236981. Any of such applications or modes of use of SMS are contemplated for use with present inventive method and system.

The Multimedia Messaging Service (“MMS”), as used in mobile communications networks, denotes the latest approach for transmitting messages having a multimedia content and is oftentimes described as the most recent extension of SMS and EMS messaging protocol (as described below). MMS messaging allows messaging between different mobile users and/or between mobile users and the Internet via an e-mail address. Unlike SMS messaging, MMS can include not just text, but also sounds, images, video, animation and graphics. Formats that can be embedded with MMS include text formatted with fonts, colors, and the like, images (JPEG, GIF format and animator GLF), audio (MP3, WAV, AMR, MIDI) and video (WPEG and Real Media) and various combinations thereof. Images may be downloaded from WAP sites, for example, as selected from a menu within a phone or may be, for instance, photos from a built-in camera in the phone which are now commonplace, with MMS capable phones first appearing in 2002.

The present invention also contemplates the employ of the Enhanced Messaging Service “(EMS”), a type of halfway service between SMS and MMS which enables some features of MMS capability, such as text, some simple pictures and audio, and some simple graphics and animation.

MMS is a store and forward messaging service which allows mobile subscribers the ability to exchange multimedia messages with other mobile subscribers, or the ability to send multimedia content in a single message and to send the message to multiple recipients, which provides an ideal messaging system for use with the present invention.

A MMS message can be created, for example, by using a built-in or accessory camera, or it may be composed of sound and/or images previously stored in the mobile phone, such as downloaded from an Internet website. Without a phone being turned on, an MMS message can be stored and forwarded to a recipient as soon as the phone is turned on. Additionally, one or a multiple of MMS messages may be stored in a user's handset and reviewed or forwarded at a later date. Further, unlike an SMS message which is limited to 160 bytes, an MMS message is a single entity as opposed to a collection of attachments and has no size limit with the possibility of being many Kbytes in size. Each MMS message contains a number of pages with each page containing an image with text and/or audio or animation, such as a PowerPoint presentation, which can be sent in a single message and downloaded in a user's phone device (or any phone device or other device as desired) through a WAP site.

Any conventional, or non-conventional telephone or mobile phone device, or equivalent, is contemplated for use in the inventive method and system, including cell phones from any catalog of the many mobile phone device vendors, some of which have the capability and appearance of a personal computer, or which are generally multifunctional. The inventive method is also contemplated for use with any conventional land line and mobile/wireless communication network.

The vending and purchase of any goods and services which can be bought and sold over the telephone is contemplated in conjunction with the present invention. For example, as used herein the term “telephone services” is defined as any service that can be conducted over the telephone lines, such as a dedicated or public telephone system or a wireless telephone system or operation, with some non-limiting examples including, for illustration purposes only, dating services, match making services, adult content services, technical support or know-how services, language learning, tutoring or other educational services involving a virtually limitless array of subject matter and topics. Further illustrative examples of services offered, bought and sold via the present inventive method and system can include any type of professional services, such as legal services, medical services, psychiatric or psychological services, marriage counseling services and counseling services in general, which can be advantageously provided by the invention in an on-the-spot emergency basis if need be. Additional examples of services include gaming, gambling, and handicapping services, architectural, business, and accounting services, and really anything or any type of information that can be sold on a time basis for a fee.

Examples of goods and/or related services which may be purchased, such as time-purchased, via the present invention, include, without limitation, ringtones, wallpaper for phone displays, games, tolls, fines, music, movies, and computer software and all executable products, financial products, application products, design and engineering products, drawing and architectural products and any and all search products including personal histories, genealogies, criminal histories, automotive and product histories, business histories, credit histories and the like. In short, a description of services and goods time-purchased in accordance with the present invention can only be limited by one's imagination.

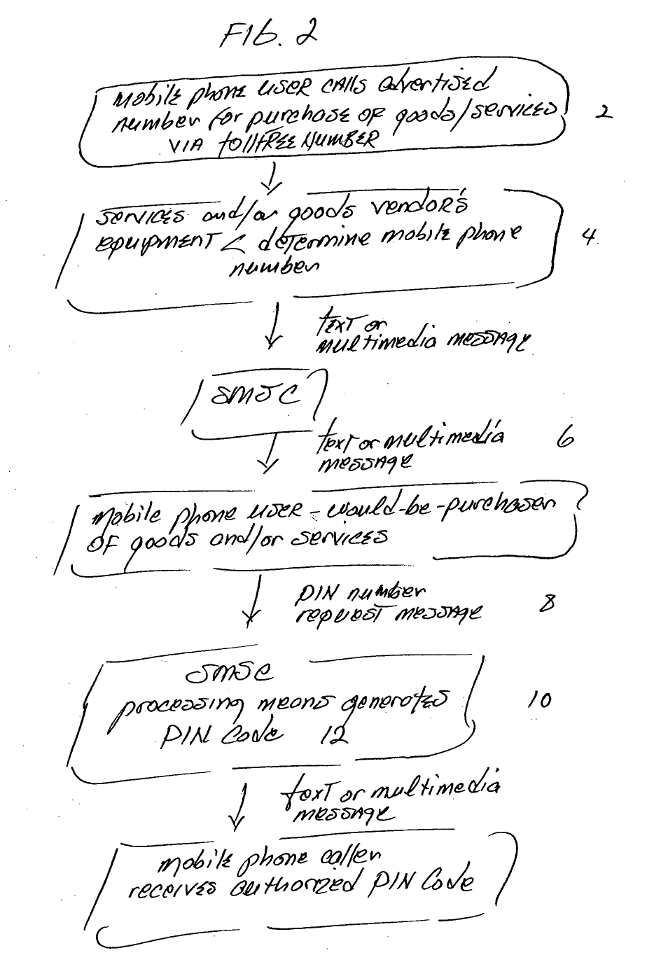

Turning now to FIG. 2, there is depicted a flow diagram of another preferred embodiment of the inventive method and system with various optional components and features, and which is highly flexible and alterable to any desired or contemplated scheme or business plan without departing from the scope of the invention. In FIG. 2, a mobile phone device, e.g. cell phone, user and would-be purchaser (202) places a call to a number which is one advertised or made available for purchase of various services and/or products. The number called may be a toll-free number. The call is received by a service vendor's equipment (204), and the caller's mobile telephone number is determined. Next, the caller, would-be purchaser, is forwarded an SMS text message or EMS or MMS multimedia message (206) which can take any of several forms. For example, in one embodiment, the caller may be sent a specific text message which offers a way to bill the cost or fee of the desired purchased services and/or products to their cell phone service. In another embodiment, the caller may be offered via a text or multimedia message routed to the cell phone number a menu choice number for the cell phone user to actuate with an instructional prompt as to fee payment methods. After receiving specific use instructions from any of such embodiments, as for example, prompted on the vendor's configured platform, the cell phone caller can then send a “pin number request” message (208) which is received and processed by a Short Message Service Center (SMSC) (210). Optionally, the caller may make a toll-free call to request a PIN code for access to services and/or goods. Next, the SMSC (210), after receipt and processing of the request message (208), through, for example, automated means for preconfigured platform (212), or toll-free call as the case may be, forwards the cell phone user an SMS message containing an authorized PIN code (214), or perhaps one or a plurality of text or multimedia messages, such as instructional and/or warranty or terms of use messages in concatenated form, in conjunction with an authorized PIN code. An example message can take the form of the following sequence:
i) “Thank you for joining our service!”
ii) “Remember, your PIN code is good for only XX minutes worth of access to our service and is good for a period of XX hours”.
iii) “Here is your PIN Code, XXX. Call the number you originally called and enter your PIN code as requested. Please allow for X minutes for activation.

The activated PIN code can then be communicated to the vendor's operation for verification purposes, for example, preferably through a dedicated IP address. Upon receipt, the vendor can then store the activated PIN code for database retrieval, read and verify for say, a period of XX hours. After the purchased prescribed time period has elapsed, the vendor can then delete the PIN Code, for example, by time lapse automatic means, from an approved list for reissue and reactivation for future timed service purchases.

As can be seen, many other options and features may be implemented with this preferred embodiment, such as, for example, and without limitation, the cycle of caller purchase of timed vendor provided services via text or multimedia messaging being repeated a plurality of times, a feature limiting service(s) purchases to set maximum fee of services purchased per time period, such as a maximum dollar amount of timed services purchased per month, or a social security number verification and/or age verification for the timed purchase of certain services. Additionally, the issuance of PIN codes may be determined by algorithm or an equivalent random generator such that assigned patterns of numbers can be avoided in an effort to thwart fraudulent service usage.

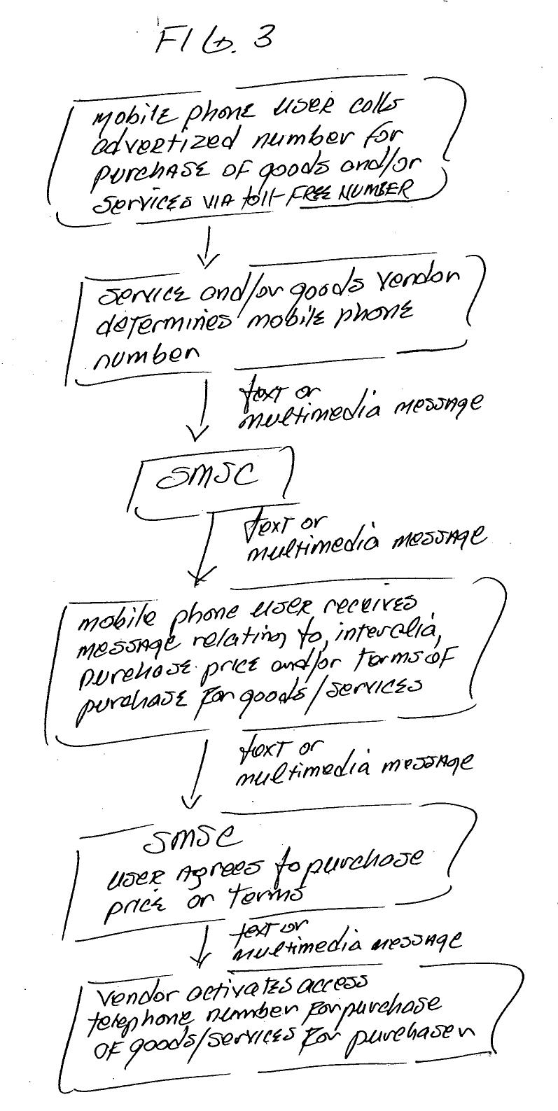

A wide array of additional embodiments of the present invention is also contemplated, such as, for example, and without limitation, the method and system illustrated in FIG. 3, wherein a PIN code is not employed or required. In such embodiments, upon receiving text or multimedia messages and agreeing to terms, such as billing charges and the like, a telephone number for the receipt of services (or goods as desired) will be activated by the inventive method and system for a prescribed amount of time, and reactivated for additional prescribed amounts of time as the case may be.

In other embodiments, a telephone call from either a land line or mobile phone, such as a toll-free call, may be placed to a service provider or a vendor of services and goods, and upon agreement to terms of purchase, a telephone number or code for receipt of services and/or goods may be provided, such as on a timed basis.

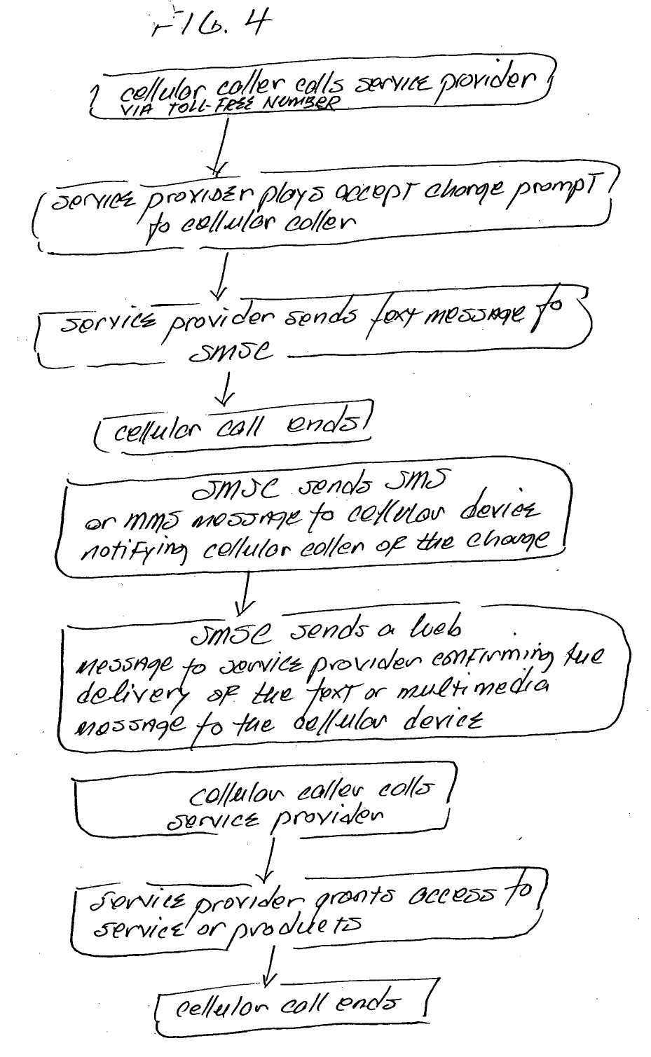

In another example shown in FIG. 4, in accordance with the invention, a cellular caller calls a service provider with a contemplated purchase of goods and/or services. The service provider in response plays an accept charge prompt to the cellular caller, which may be, for example, an automated message. The service provider then sends an SMS message to a SMS Service Center (SMSC) and the cellular call ends. Next, the SMSC sends a text or multimedia message to the mobile phone device of the cellular caller notifying the cellular caller of charges for goods and/or services. The SMSC also sends a Web message to the service provider confirming the delivery of the text or multimedia message to the caller's mobile phone device. The caller then calls the service provider, again, preferably by way of a toll free number, and depending upon, for example, whether charges were accepted, the service provider grants the caller access to service(s) and/or product(s).

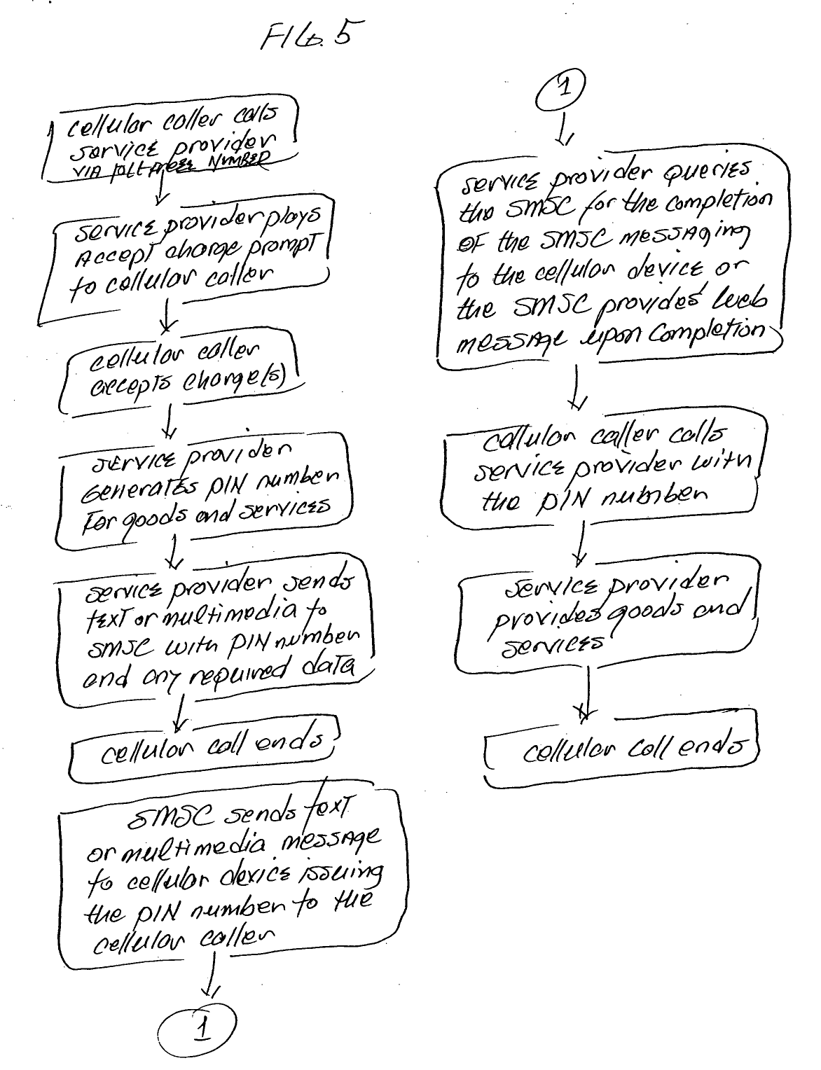

In FIG. 5, another exemplified embodiment of the invention is provided, in which a cellular caller calls a service provider with the contemplated purchase of goods and/or services, for example, by way of a toll-free number, and in response the service provider plays an accept charge prompt to the cellular caller who accepts the charge(s). The service provider then generates a PIN number for access to goods and/or services and sends an SMS message to an SMSC and the generated PIN number and any or all other required data. The SMSC next sends an SMS message to the cellular caller in which the PIN number is issued to the caller. Optionally, the service provider may query the SMSC for completion of the SMSC messaging to the mobile phone device of the cellular caller, or the SMSC may provide a Web message to the service provider confirming the SMS message to the caller and issuance of the PIN number. The cellular caller may then call the service provider and provide the issued PIN number for access to goods and/or services as desired or contemplated.

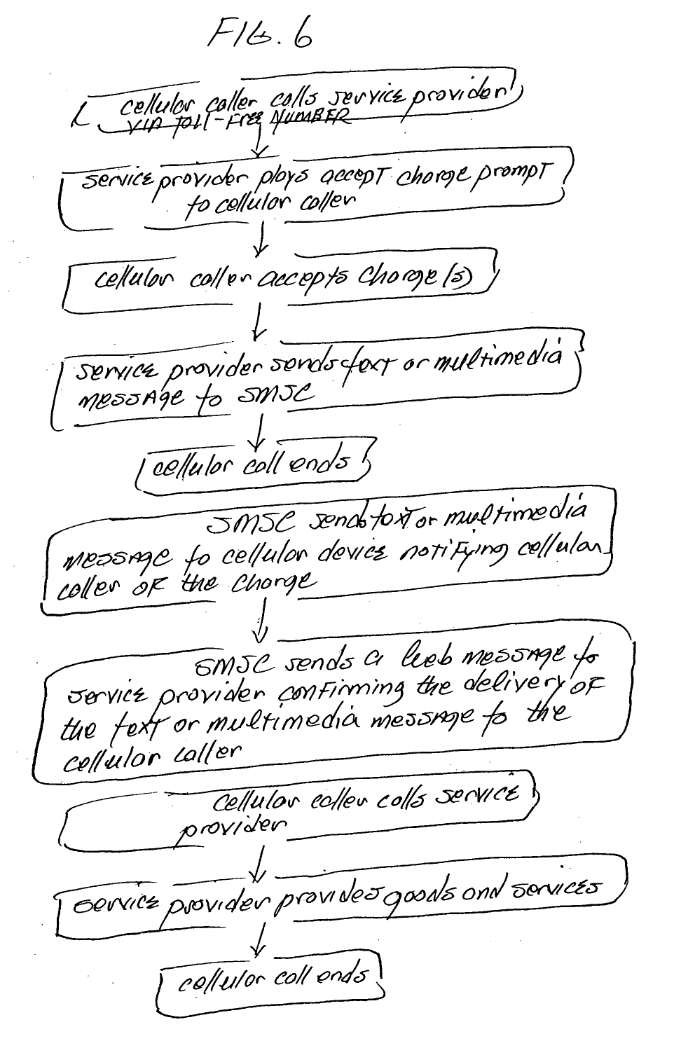

Next, in FIG. 6, an additional embodiment of the invention is schematically portrayed, in which a cellular caller, would-be purchaser, first calls a service provider, again, for instance, by way of an advertised number, such as a toll-free call, and in response the service provider plays an accept charge prompt to the cellular caller who either accepts or does not accept the proposed charges and/or terms of purchase for contemplated goods and/or services. Upon acceptance, the service provider sends an SMS message to the SMSC, which sends an SMS message to the mobile phone device of the cellular caller notifying the caller of the charge(s). Optionally, the SMSC can send a Web message to the service provider confirming the delivery of the SMS message to the mobile phone device of the cellular caller. The cellular caller may then call the service provider to gain access to contemplated goods and/or services.

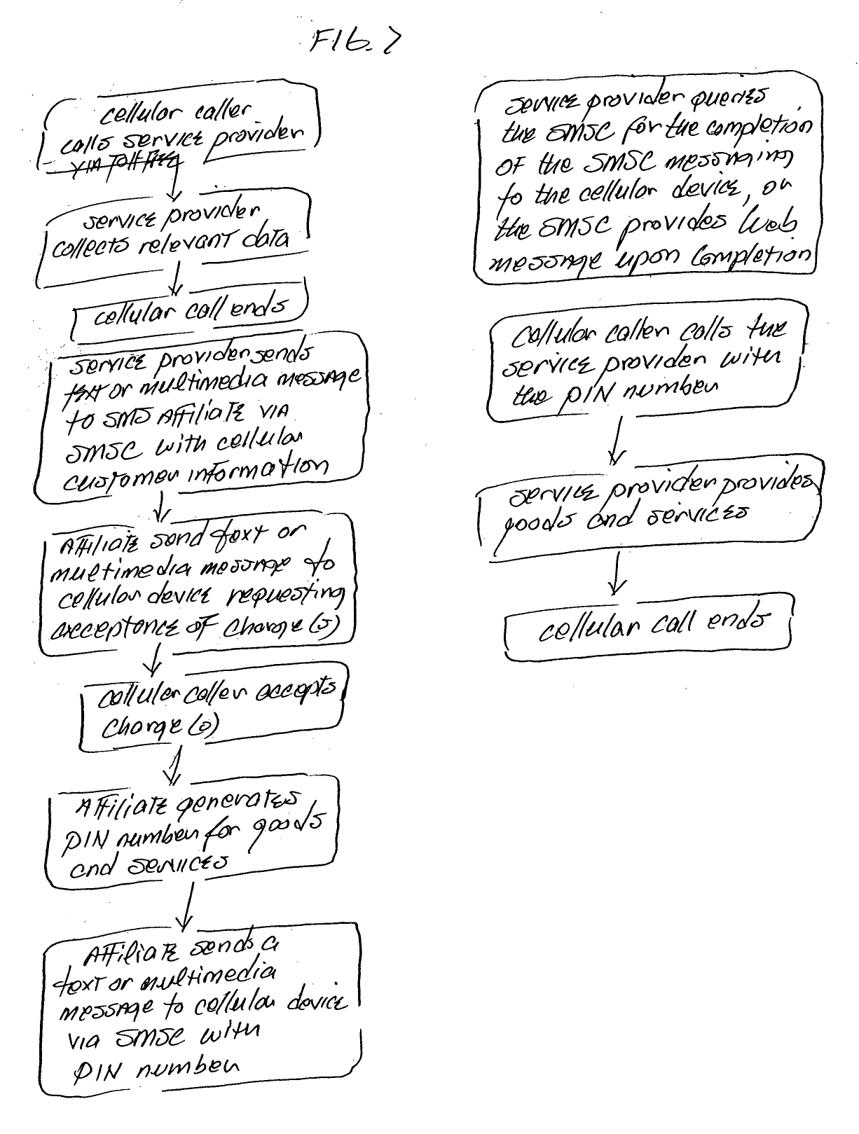

In the schematically portrayed embodiment of FIG. 7, a cellular caller or would-be purchaser calls a service provider with the contemplated purchase of goods and/or services, for instance, by way of a toll-free call, and in response, the service provider obtains from the caller relevant and/or requested information, such as identification, electronic purchase information and the like. The service provider then sends an SMS message to an SMS affiliate via an SMSC with the cellular customer information as provided. The affiliate sends an SMS message to the mobile phone device of the cellular caller requesting acceptance of the proposed charge(s) and/or purchase terms. Upon acceptance of same by the cellular caller the affiliate generates a PIN number for purchase or access of the caller to contemplated goods and/or services, and sends an SMS message to the mobile phone device of the cellular caller via an SMSC presenting the PIN number.

Optionally, the service provider may query the SMSC for completion of the SMSC messaging to the mobile phone device of the cellular caller, or a Web message may be provided to the service provider by the SMSC upon completion. The cellular caller then calls the service provider and presents the issued PIN number for access to contemplated goods and/or services.

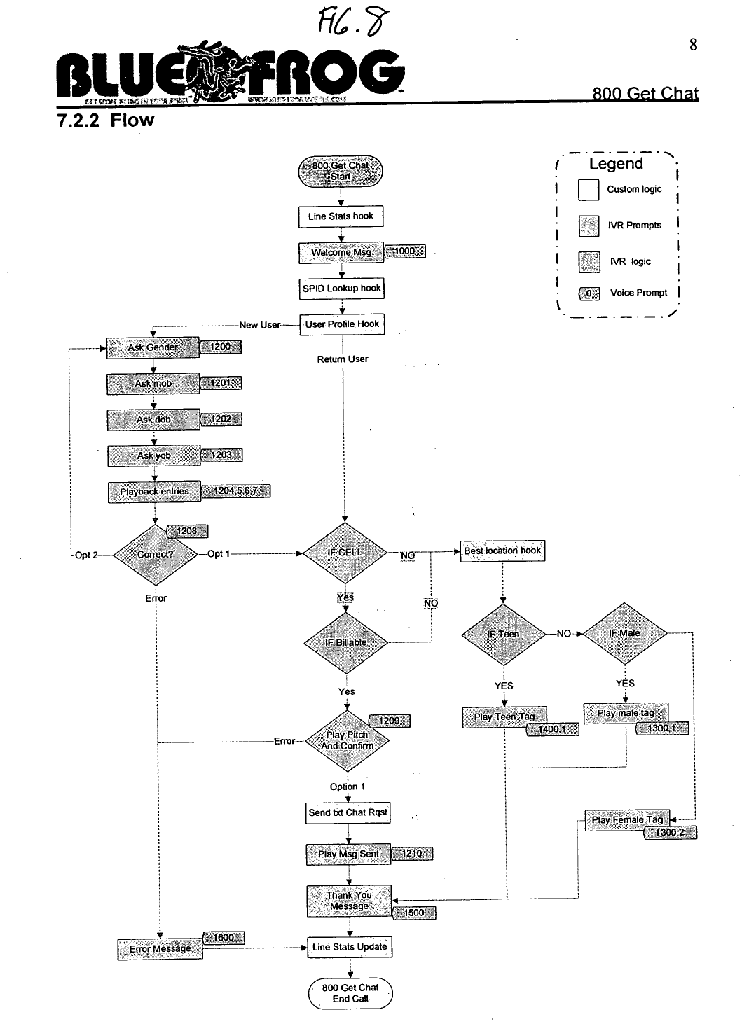

As further embodiment of the invention is shown in the flow diagram of FIG. 8 which depicts a preferred flow chart for implementing a system for carrying out the method of the invention.

It is also contemplated that the present invention be used in conjunction with any and all conventional SMS, EMS and MMS methodology and technology, such as, for example, services which allow for sending and receiving text and multimedia messages to and from an application or a person's e-mail, and the like.

As will be further appreciated by those persons skilled in the art, the present inventive method and system, inclusive of one or more embodiments of its operation through various software and hardware systems, affords distinct business advantages not previously available to vendors relating to the sale of services and products. In this aspect, the present invention provides novel methods of conducting an array of business functions comprising, inter alia, designing, manufacturing, using, marketing, selling, licensing, and/or leasing the inventive subject matter, developing business good will, developing valuable trademark rights in conjunction with use thereof, and further in providing novel methods of business entity formation, such as partnerships, corporations, joint ventures and other collaborations for the purpose of exploiting the business of the inventive subject matter.

While this invention has been described in connection with what is presently considered to be the most practical and preferred embodiments, it is to be understood that the invention is not to be limited in any way to the disclosed embodiments as such are merely set forth for illustrative purposes. The present inventive method and system, and methods for conducting business in general, are intended to cover an array of various modification and equivalent arrangements, all of which are contemplated for inclusion within the scope and spirit of the disclosure and appended claims.

We claim:

1. A method for purchase of goods and/or services comprising the steps of,
(a) a caller or would-be purchaser calling a service provider/vendor from a phone device selected from a land line device and a mobile phone device, optionally by way of a toll-free number;
(b) determining whether the caller is calling from a land line device or a mobile phone device, and responding accordingly;
(c) if a mobile phone device is determined, a text or multimedia message being forwarded to the would-be purchaser's mobile phone device relating to purchase of services and/or goods, or purchase options and/or terms of procuring services and/or goods;
(d) upon acceptance of the contents of the text or multimedia message, the would-be purchaser or caller is billed or charged a fee which allows the caller's access to telephonic and/or Internet vendor provided services and/or goods for a first determined time period.

2. The method of claim 1 further comprising the step wherein upon completion of the first determined time period, the caller's mobile phone device is forwarded a second text or multimedia message relating to the caller's agreement or approval of the contents of the second text and/or multimedia message to be billed or charged a fee for a second determined time period for access to telephonic and/or Internet vendor provided services and/or goods.

3. The method of claim 2 comprising a plurality of text and/or multimedia messages which are forwarded to the caller relating to the caller's agreement or approval thereof to be billed or charged a fee for a plurality of determined time periods for access to telephonic and/or Internet vendor provided services and/or goods.

4. The method of claims and 1, 2, and 3 wherein said services and goods are selected from the group consisting off dating services, matchmaking services, adult oriented services, technical support or know how services, tutoring, language learning, and educational services, professional services including legal, medical, psychiatric, psychological, marriage counseling and counseling services in general, gaming and gambling services, handicapping services, ringtones, wallpaper for phone displays, computer software and any and all executable products such as games, financial products, application products, design and engineering products, drawings and architectural products, tolls, fines, music, and any and all search products, including personal histories, genealogies, criminal histories, automotive and other product histories, credit histories, business histories and financial histories.

5. A system comprising a method for purchase of goods and/or services comprising the steps of,
(a) a caller or would-be purchaser calling a service provider/vendor from a land line or mobile phone device, optionally by way of a toll-free number;
(b) determining if the caller is calling from a land line device or a mobile phone device and responding accordingle;
(c) if it is determined that the a call is from a mobile phone device, a text or multimedia message being forwarded to the would-be purchaser's mobile phone device relating to purchase of services and/or goods, or options and/or terms of procuring services and/or goods;
(d) upon acceptance of the contents of the text or multimedia message, the would-be purchaser or caller is billed or charged a fee which allows the caller's access to telephonic and/or Internet vendor provided services and/or goods for a first determined time.

6. The system of claim 5 further comprising the step whereupon completion of the first determined time period, the caller's mobile phone device is forwarded a second text or multimedia message relating to the caller's agreement or approval of the contents of the second text or multimedia message to be billed or charged a fee for a second determined time period for access to telephonic and/or Internet provided vendor provided services and/or goods.

7. The system of claim 6 comprising a plurality of text and/or multimedia messages which are forwarded to the caller relating to the caller's agreement or approval thereof to be billed or charged a fee for a plurality of determined time periods for access to telephonic and/or Internet vendor provided services and/or goods.

8. The systems of claims 5, 6, and 7 wherein said services and goods are selected from the group consisting of dating services, matchmaking services, adult oriented services, technical support or know how services, tutoring, language learning, educational services, professional services including legal, medical, psychiatric, psychological, marriage counseling and counseling services in general, gaming and gambling services, handicapping services, ringtones, wallpaper for phone displays, computer software and any and all executable products such as games, financial products, application products, design and engineering products, drawings and architectural products, tools, fines, music, and any and all search products, including personal histories, genealogies, criminal histories, automotive and other product histories, financial histories, business histories and credit histories.

9. A method of conducting business comprising the use of a method for purchase of goods and/or services such as recited in claim 1.

10. A method of conducting business comprising the use of a method for purchase of goods and/or services such as recited in claim 2.

11. A method of conducting business comprising the use of a method for purchase of goods and/or services such as recited in claim 3.

12. A method of conducting business comprising the use of a method for purchase of goods and/or services such as recited in claim 4.

13. A method of conducting business comprising the use of the system recited in claim 5.

14. A method of conducting business comprising the use of the system recited in claim 6.

15. A method of conducting business comprising the use of the system recited in claim 7.

16. A method of conducting business comprising the use of the system recited in claim 8.
